(19) United States
(12) Patent Application Publication
(10) Pub. No.: US 2025/0118488 A1
(43) Pub. Date: Apr. 10, 2025

(54) INSULATION STRUCTURE FOR TRANSFORMER

(71) Applicant: University of Seoul Industry Cooperation Foundation, Seoul (KR)

(72) Inventors: Seung Hwan LEE, Seoul (KR); Eun Chong NOH, Seoul (KR)

(21) Appl. No.: 18/906,146

(22) Filed: Oct. 3, 2024

(30) Foreign Application Priority Data
Oct. 5, 2023 (KR) 10-2023-0132602
Oct. 5, 2023 (KR) 10-2023-0132606

(51) Int. Cl. H01F 27/32; H01F 27/24; H01F 27/30; H01F 27/36

(52) U.S. Cl. CPC H01F 27/327; H01F 27/24; H01F 27/306; H01F 27/36

(57) ABSTRACT

Disclosed is an insulation structure for a transformer. The insulation structure according to the present inventive concept includes a low voltage part winding, a ferrite core, and a high voltage part having a high voltage part winding wound on one side of the ferrite core, an epoxy mold located to surround the high voltage part winding, a terminal protruding outward from one side of the epoxy mold, and a shield located to surround the outer peripheral surface of the terminal, wherein the epoxy mold has a conductive coating layer formed on the outer surfaces thereof in such a way as to be connected to ground or the ferrite core.

### TECHNICAL FIELD

The present inventive concept relates to an insulation structure for a transformer, more specifically to an insulation structure for a transformer that is capable of blocking the leakage of an electric field or keeping a voltage difference between an interior of a mold and a core or a voltage difference between an interior of an enclosure and a high voltage side of an internal module, thereby minimizing the entire volume and weight of the transformer and ensuring stable insulation performance.

### BACKGROUND ART

A high frequency molded transformer is a dry type transformer that uses epoxy resin having high insulation strength for its windings to insulate the windings. The high frequency molded transformer has better flame resistance and lesser loss than an oil-filled transformer or dry type transformer, thereby being excellent in saving energy. Further, the high frequency molded transformer is completely sealed so that it is advantageous in view of moisture resistance and repair check.

The high frequency molded transformer having the above-mentioned advantages is applicable for railway vehicles, eco-friendly energy systems such as a photovoltaic power generation system, a wind power generation system, and the like, and high-voltage direct current (HVDC) transmission systems, which will be developed in the future.

However, if an electric field leaks to an external air layer from the outer surfaces of an epoxy mold, insulation breakdown may occur on the air layer. Therefore, the epoxy mold of the high frequency molded transformer should be designed to be increased in thickness to prevent the insulation breakdown from occurring due to the electric field leakage.

This requires an insulation structure for the high frequency molded transformer that is capable of reducing the volume of the epoxy mold, while the epoxy mold is being kept at given insulation strength, thereby decreasing the weight of the transformer.

Further, a medium voltage semiconductor transformer is a device that converts a distribution voltage of a 22. 9 or 25 kV medium voltage level into a voltage at which a commercial switching device is operable and supplies the converted voltage. As electrification products have recently increased, new power conversion devices and electronic technologies that replace existing transformers are needed, and many studies therefor have been dynamically made.

The semiconductor transformers have better advantages than the existing transformers in achieving high efficiency, easiness in control of a voltage and a current, and degrees of weight and volume. Therefore, the semiconductor transformers are applicable to railway vehicles, eco-friendly energy systems such as a photovoltaic power generation system, a wind power generation system, and the like, HVDC transmission systems, and electric vehicle quick charging, which will be developed in the future.

Further, an insulation technology for the medium voltage semiconductor transformer has a big influence on the improvement in the insulation capability of the transformer, price competitively acquirement thereof, and the improvement in the utility thereof. As a conventional insulation technology uses an air layer, an insulation distance between components is undesirably long to ensure a withstanding voltage. In this case, the semiconductor transformer becomes bulky. Further, it is impossible to apply the conventional insulation technology to railway vehicles where volume limitations are strict.

Therefore, there is a definite need to develop an insulation structure that is capable of enhancing insulation strength, while decreasing an insulation distance between components, thereby minimizing the volume of a semiconductor transformer.

### DISCLOSURE

### Technical Problem

To solve the above-mentioned problems occurring in the related art, accordingly, it is an object of the present inventive concept to provide an insulation structure for a transformer that is capable of blocking the leakage of an electric field or keeping a voltage difference between an interior of a mold and a core, thereby minimizing the entire volume and weight of the transformer and ensuring stable insulation performance.

It is another object of the present inventive concept to provide an insulation structure for a semiconductor transformer that is capable of blocking the leakage of an electric field and keeping a voltage difference between an interior of an enclosure and a high voltage side of an internal module, thereby reducing an insulation distance between components and minimizing the entire volume and weight of the semiconductor transformer.

### Technical Solution

To accomplish the above-mentioned objects, according to one aspect of the present inventive concept, there is provided an insulation structure for a transformer, including a low voltage part winding, a ferrite core, and a high voltage part, wherein the high voltage part may include: a high voltage part winding wound on one side of the ferrite core; an epoxy mold located to surround the high voltage part winding; a terminal protruding outward from one side of the epoxy mold; and a shield located to surround the outer peripheral surface of the terminal, and the epoxy mold may have a conductive coating layer formed on the outer surfaces thereof in such a way as to be connected to ground or the ferrite core.

According to an embodiment of the present inventive concept, a distance between the conductive coating layer and the high voltage part winding may be greater than or equal to a horizontal distance between the ferrite core and the high voltage part winding or a height distance between the high voltage part winding and the ferrite core.

According to an embodiment of the present inventive concept, the conductive coating layer may be spaced apart from the ferrite core and connected to the ground through a connection line.

According to an embodiment of the present inventive concept, the conductive coating layer may be applied to come into close contact with the ferrite core.

To accomplish the above-mentioned objects, according to another aspect of the present inventive concept, there is provided an insulation structure for a transformer equipped with an internal module, including: an enclosure made of an insulating material; a first conductive coating layer applied to the outer surfaces of the enclosure; and a second conductive coating layer applied to the inner surfaces of the enclosure, wherein the first conductive coating layer may be connected to ground and the second conductive coating layer may be connected to a high voltage side of the internal module.

According to an embodiment of the present inventive concept, the enclosure may have a corner curvature (R) greater than or equal to ½ of a thickness (A) thereof.

According to an embodiment of the present inventive concept, the thickness (A) of the enclosure may be greater than or equal to 10 T, and a distance between the internal module and the inner surface of the enclosure may be greater than or equal to 5 mm.

According to an embodiment of the present inventive concept, the enclosure may include: a body for receiving the internal module; a first drawn part protruding outward from one side of the body in such a way as to be connected to a low voltage part of the internal module; and a second drawn part protruding outward from the other side of the body in such a way as to be connected to a high voltage part of the internal module, the second drawn part being seven times longer than the first drawn part.

### [Effective Advantages of the Inventive Concept]

The insulation structure for a transformer according to one embodiment of the present inventive concept is configured to allow the surfaces of the epoxy mold for the high voltage part to be coated with the conductive material and thus connected to the ground or ferrite core, so that even if the epoxy mold is low in thickness, the electric field leakage to the outside is prevented to minimize the entire volume and weight of the transformer and stable insulation is ensured to be easy in achieving module integration and packaging.

Further, the insulation structure for a transformer according to one embodiment of the present inventive concept is configured to allow the surfaces of the epoxy mold of the high voltage part to have an equal potential with the core or ground, so that the epoxy mold having relatively low thermal conductivity is reduced in thickness, thereby improving heat emission performance.

Furthermore, the insulation structure for a transformer according to one embodiment of the present inventive concept is configured to prevent electric field leakage to the outside of the epoxy mold of the high voltage part from occurring, so that a degree of freedom in design is improved, without considering the influence of the electric field on the outside of the epoxy mold.

Besides, the insulation structure for a transformer according to one embodiment of the present inventive concept is configured to allow a distance between the conductive coating layer and the high voltage part winding to have a given relation with each other, thereby stably providing the insulation characteristics required by the customer.

The insulation structure for a semiconductor transformer according to another embodiment of the present inventive concept is configured to allow the conductive materials to be coated on the inner and outer surfaces of the enclosure and then connected to the ground and the high voltage side, so that as insulation distances among the components are reduced to minimize the volume and weight of the semiconductor transformer, there is no need to additionally ensure an insulation distance from another module, thereby being easy in making a stack structure and achieving module integration and packaging.

Further, the insulation structure for a semiconductor transformer according to another embodiment of the present inventive concept is configured to allow the first conductive coating layer to be applied to the outer surfaces of the enclosure and then connected to the ground, so that the electric field leakage is blocked to prevent the insulation breakdown from occurring on the outer surfaces of the enclosure.

Furthermore, the insulation structure for a semiconductor transformer according to another embodiment of the present inventive concept is configured to allow the second conductive coating layer to be applied to the inner surfaces of the enclosure and then connected to the high voltage side of the internal module, so that as a voltage difference between the components inside the internal module and the second conductive coating layer applied to the inner surfaces of the enclosure is not big, no insulation breakdown occurs inside the enclosure.

Besides, the insulation structure for a semiconductor transformer according to another embodiment of the present inventive concept is configured to allow the thickness of the enclosure and the distance between the inner surface of the enclosure and the internal module to be greater than or equal to the given values, thereby stably achieving the insulation characteristics required by the customer.

Moreover, the insulation structure for a semiconductor transformer according to another embodiment of the present inventive concept is configured to allow the corner curvature of the enclosure to have a given relation with the thickness of the enclosure, so that the electric field around the respective corners is distributed to prevent the insulation breakdown from occurring around the corners of the enclosure.

Additionally, the insulation structure for a semiconductor transformer according to another embodiment of the present inventive concept is configured to allow the length of the second drawn part and the length of the first drawn part to have a given relation with each other, thereby stably achieving the insulation characteristics required by the customer.

### DESCRIPTION OF DRAWINGS

FIG. 1 is a perspective view showing an insulation structure for a high frequency molded transformer according to an embodiment of the present inventive concept.

FIG. 2 is a perspective view showing a state where a mold is removed from the insulation structure for the high frequency molded transformer of FIG. 1.

FIG. 3 is an enlarged sectional view showing the mold of the insulation structure for the high frequency molded transformer according to the embodiment of the present inventive concept.

FIG. 4 is a longitudinal sectional view showing an example of the insulation structure for the high frequency molded transformer according to the embodiment of the present inventive concept.

FIG. 5 is a longitudinal sectional view showing another example of the insulation structure for the high frequency molded transformer according to the embodiment of the present inventive concept.

FIG. 6 is a side view showing a position relation between windings and the mold of the insulation structure for the high frequency molded transformer according to the embodiment of the present inventive concept.

FIG. 7 is a top view showing the position relation between the windings and the mold of the insulation structure for the high frequency molded transformer according to the embodiment of the present inventive concept.

FIG. 8 is a graph showing an insulation analysis result of the insulation structure for the high frequency molded transformer according to the embodiment of the present inventive concept.

FIG. 9 is a graph showing an insulation analysis result of the insulation structure for the high frequency molded transformer according to the embodiment of the present inventive concept.

FIG. 10 is a graph showing an internal insulation analysis result of a high voltage part of the insulation structure for the high frequency molded transformer according to the embodiment of the present inventive concept.

FIG. 11 is a schematic view showing an insulation structure for a semiconductor transformer according to another embodiment of the present inventive concept.

FIG. 12 is an enlarged sectional view showing an enclosure of the insulation structure for the semiconductor transformer according to the embodiment of the present inventive concept.

FIG. 13 is a perspective view showing the semiconductor transformer to which the insulation structure according to the embodiment of the present inventive concept is applied.

FIG. 14 is a sectional view showing the semiconductor transformer to which the insulation structure according to the embodiment of the present inventive concept is applied.

FIG. 15 is an enlarged sectional view showing a corner of the enclosure of the insulation structure for the semiconductor transformer according to the embodiment of the present inventive concept.

FIG. 16 is a sectional view showing the insulation analysis on the enclosure of the insulation structure for the semiconductor transformer according to the embodiment of the present inventive concept.

### MODE FOR INVENTIVE CONCEPT

Hereinafter, an embodiment of the present inventive concept will be described in detail with reference to the attached drawings so that it may be carried out easily by those having ordinary skill in the art. Before the present inventive concept is disclosed and described, it is to be understood that the disclosed embodiments are merely exemplary of the inventive concept, which can be embodied in various forms. Also, in explaining the example embodiments, detailed description on known elements or functions will be omitted if it is determined that such description will interfere with understanding of the embodiments. For reference numerals, with respect to the same elements, even though they may be displayed in different drawings, such elements use same reference numerals as much as possible.

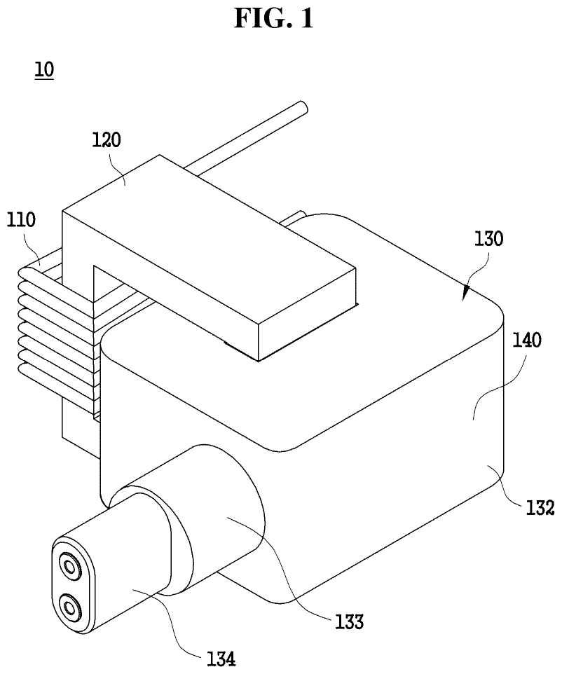

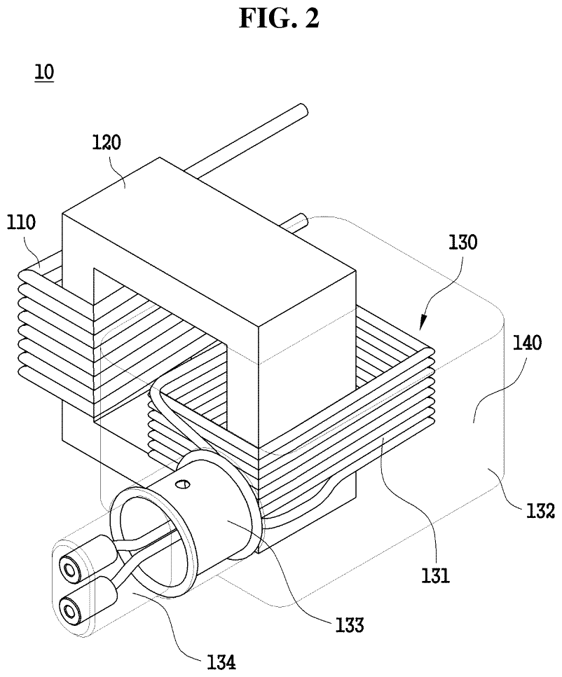

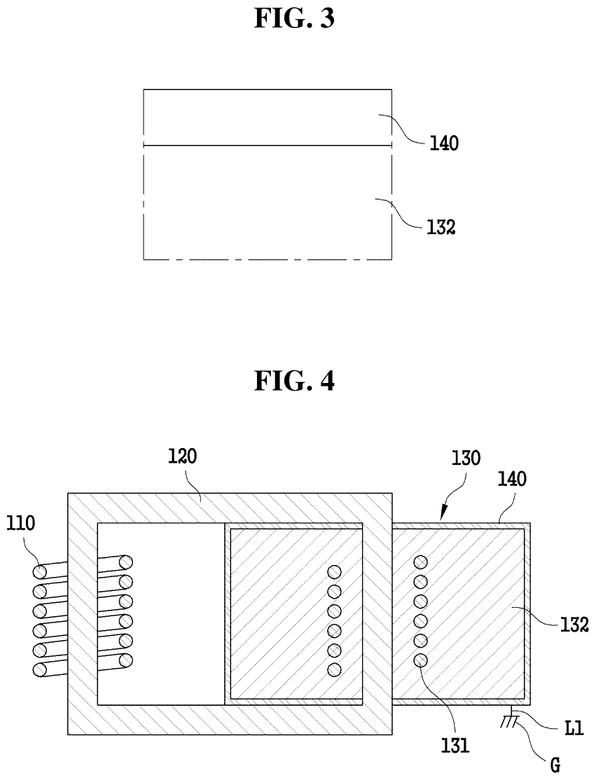

Hereinafter, an explanation of an insulation structure for a high frequency molded transformer according to an embodiment of the present inventive concept will be given in detail with reference to the attached drawings. FIG. 1 is a perspective view showing an insulation structure for a high frequency molded transformer according to an embodiment of the present inventive concept, FIG. 2 is a perspective view showing a state where a mold is removed from the insulation structure for the high frequency molded transformer of FIG. 1, and FIG. 3 is an enlarged sectional view showing the mold of the insulation structure for the high frequency molded transformer according to the embodiment of the present inventive concept.

Referring to FIGS. 1 to 3, an insulation structure 10 for a high frequency molded transformer according to an embodiment of the present inventive concept includes a low voltage part winding 110, a ferrite core 120, a high voltage part 130, and a conductive coating layer 140.

The insulation structure 10 for a high frequency molded transformer is a structure that is made using an epoxy mold 132 having higher insulation strength than air and the conductive coating layer 140, thereby achieving high voltage insulation, improving insulation performance, and providing 70 kV insulation strength.

The existing high frequency molded transformer is improved in its insulation performance with an amount of epoxy, which causes the volume and weight of the epoxy to increase, and therefore, it is difficult to use it in a limited space. In the case where an electric field leaks into an external air layer, further, insulation breakdown may occur on the air layer.

To solve such problems, the present inventive concept allows the surfaces of the epoxy mold of the high frequency molded transformer to have an equal potential with the core or ground, thereby blocking electric field leakage. In the case where only the epoxy mold is provided, that is, the electric field applied to the epoxy is strong so that it may leak into the external air layer, thereby resulting in the insulation breakdown of the high frequency molded transformer. However, the insulation structure 10 for a high frequency molded transformer according to the present inventive concept is configured to allow the conductive coating layer 140 to be applied to the epoxy mold and then connect the conductive coating layer 140 and a first line L1 to an external ground G, thereby blocking electric field leakage.

The low voltage part winding 110 is a coil that is wound on one side of the ferrite core 120. In this case, the low voltage part winding 110 is an output of the high frequency transformer.

The ferrite core 120 is configured to allow the low voltage part winding 110 and a high voltage part winding 131 to be wound on both sides thereof, thereby performing the conversion of power.

The high voltage part 130 is located on the other side of the ferrite core 120 and an input of the high frequency transformer. In this case, the high voltage part 130 includes the high voltage part winding 131, the epoxy mold 132, a shield 133, and a terminal 134.

The high voltage part winding 131 is a coil that is wound on the other side of the ferrite core 120.

The epoxy mold 132 is located to surround the high voltage part winding 131. The epoxy mold 132 is provided to block the leakage of the electric field produced from the high voltage part winding 131. The epoxy mold 132 extends toward one side of the ferrite core 120.

The shield 133 protrudes outward from one side of the epoxy mold 132. In this case, the shield 133 has the shape of a cylinder. For example, the shield 133 is made of a metal material. As a result, the shield 133 prevents a drawn part of the epoxy mold 132 from having insulation breakdown due to the collection of electric field thereto.

The terminal 134 protrudes outward from the interior of the shield 133. For example, the terminal 134 has a connector interface connected to a bushing. In this case, the shield 133 and the terminal 134 are formed as the drawn part of the high voltage part 130.

The conductive coating layer 140 is coated on the outer surfaces of the epoxy mold 132. That is, the conductive coating layer 140 is applied to the entire outer surface of the epoxy mold 132. For example, the conductive coating layer 140 is a conductive paint. As shown in FIG. 3, the conductive coating layer 140 is applied to the outer surfaces of the epoxy mold 132 to a given thickness.

FIG. 4 is a longitudinal sectional view showing an example of the insulation structure for the high frequency molded transformer according to the embodiment of the present inventive concept.

Referring to FIG. 4, the insulation structure 10 for a high frequency molded transformer according to the present inventive concept further includes the first line L1.

The first line L1 connects the conductive coating layer 140 and the external ground G to each other. That is, the conductive coating layer 140 is connected to the external ground G through the first line L1. In this case, the conductive coating layer 140 is spaced apart from the ferrite core 120. That is, the conductive coating layer 140 is electrically cut off from the ferrite core 120.

In this case, the conductive coating layer 140 blocks the electric field leakage through the external ground G, thereby enhancing insulation strength. Therefore, the insulation structure 10 is configured to allow the amount of epoxy used to form the epoxy mold 132 to be reduced, which decreases the weight of the epoxy. Further, the thickness of the epoxy mold 132 decreases to improve the heat emission performance of the high frequency molded transformer, so that the components of the high frequency molded transformer are prevented from being broken due to heat.

Further, the insulation structure 10 for a high frequency molded transformer according to the present inventive concept blocks the electric field leakage so that it is possible be designed freely, without considering the influence of the electric field on the outside of the epoxy mold 132, thereby improving a degree of freedom in design.

As a result, the insulation structure 10 for a high frequency molded transformer according to the present inventive concept prevents the insulation breakdown from occurring even on a higher electric field produced at a withstanding voltage of 70 kV when compared to air. For example, it is easy that the insulation structure 10 is applied to railway vehicles, a photovoltaic power generation system, and a wind power generation system.

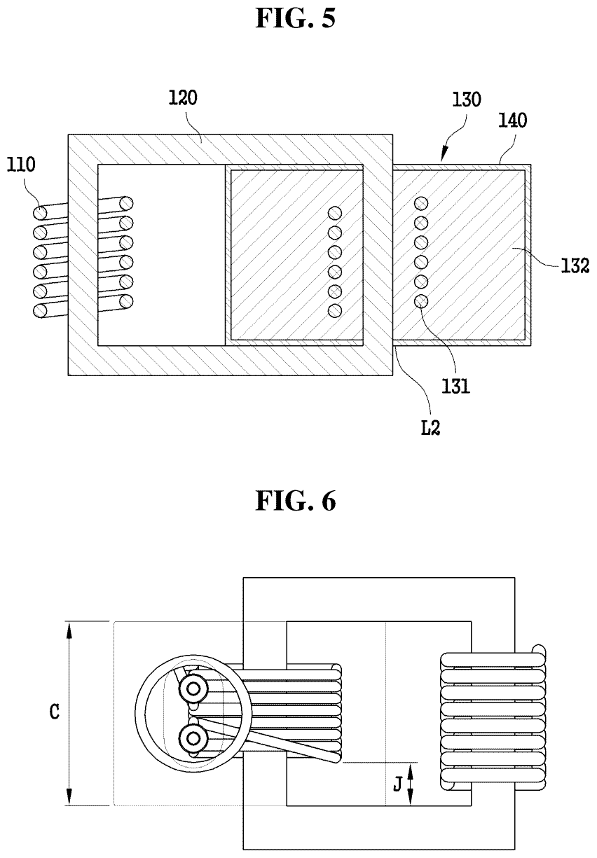

FIG. 5 is a longitudinal sectional view showing another example of the insulation structure for the high frequency molded transformer according to the embodiment of the present inventive concept.

Referring to FIG. 5, the insulation structure 10 is configured to allow the conductive coating layer 140 to be brought into close contact with the ferrite core 120. In this case, the conductive coating layer 140 comes into close contact with the ferrite core 120 through a second line L2.

In this case, the conductive coating layer 140 has the equal potential with the ferrite core 120. As a result, the insulation structure 10 applies the electric field to be applied only to the interior of the epoxy mold 120, without leaking to the outside, thereby improving the insulation strength.

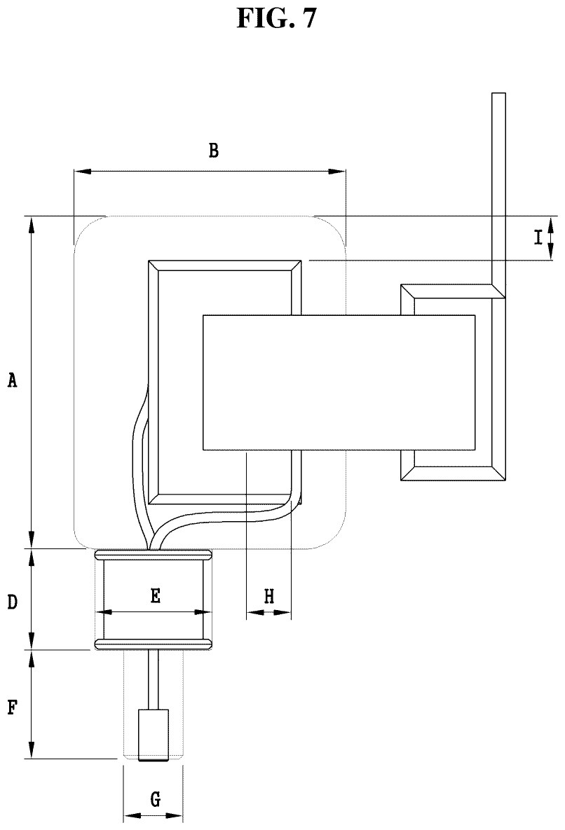

FIG. 6 is a side view showing a position relation between the windings and the epoxy mold of the insulation structure for the high frequency molded transformer according to the embodiment of the present inventive concept, and FIG. 7 is a top view showing the position relation between the windings and the epoxy mold of the insulation structure for the high frequency molded transformer according to the embodiment of the present inventive concept.

Referring to FIGS. 6 and 7, the insulation structure 10 for a high frequency molded transformer according to the present inventive concept has the rectangular epoxy mold 132. In this case, the epoxy mold 132 is made by means of vacuum impregnation for insulation.

In this case, the size of the epoxy mold 132 is determined in consideration of target characteristics of the high frequency molded transformer. In this case, a distance between the conductive coating layer 140 and the high voltage part winding 131 is greater than or equal to a horizontal distance between the ferrite core 120 and the high voltage part winding 131 or a height distance between the high voltage part winding 131 and the ferrite core 120.

Desirably, the epoxy mold 132 has a length A of 120 to 140 mm. In this case, the length A is referred to as a distance between the terminal 134 and the opposite side to the terminal 134.

Desirably, the epoxy mold 132 has a width B of 90 to 180 mm. In this case, the width B is referred to as a distance between the inside of the ferrite core 120 and the opposite side to the inside of the ferrite core 120.

Desirably, the epoxy mold 132 has a height C of 75 to 160 mm. In this case, the height C is referred to as a distance between the epoxy mold 132 and a portion coming into contact with the inside of the ferrite core 120.

Further, the size of the shield 133 is determined in consideration of the connection to an insulating enclosure and insulation characteristics thereof. Desirably, the shield 133 has a length D of 30 to 60 mm. In this case, the length D is referred to as a distance protruding outward from the surface of the epoxy mold 132.

Desirably, the shield 133 has a width E of 50 to 75 mm. In this case, the width E is referred to as a distance between both sides of the shield 133.

Further, the size of the terminal 134 is determined in consideration of smooth connection. Desirably, the terminal 134 has a length F of 40 to 70 mm. In this case, the length F is referred to as a distance between the end of the shield 133 and the end of the terminal 134.

Desirably, the terminal 134 has a width G of 25 to 40 mm. In this case, the width G is referred to as a distance between both sides of the terminal 134.

Desirably, a distance H between the ferrite core 120 and the high voltage part winding 131 is 20 mm. In this case, the distance H is referred to as a distance between the inner surface of the ferrite core 120 and the inside of the high voltage part winding 131. Desirably, a distance I between the high voltage part winding 131 and the outer surface of the epoxy mold 120 is 20 mm. In this case, the distance I is referred to as a distance between the outside of the high voltage part winding 131 and the outer surface of the epoxy mold 120 on the opposite side to the shield 134.

Desirably, a height J between the high voltage part winding 131 and the ferrite core 120 is 20 mm. In this case, the height J is referred to as a distance between the underside of the high voltage part winding 131 and the inner surface of the ferrite core 120.

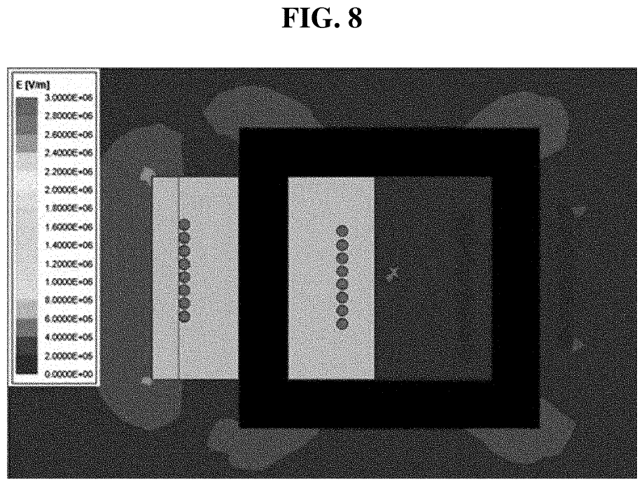

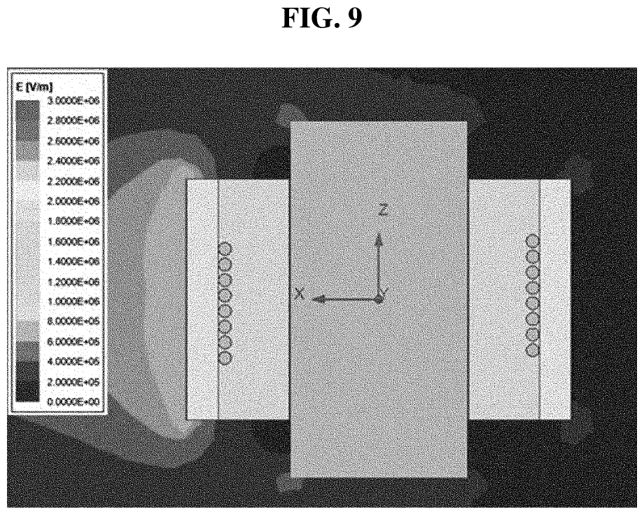

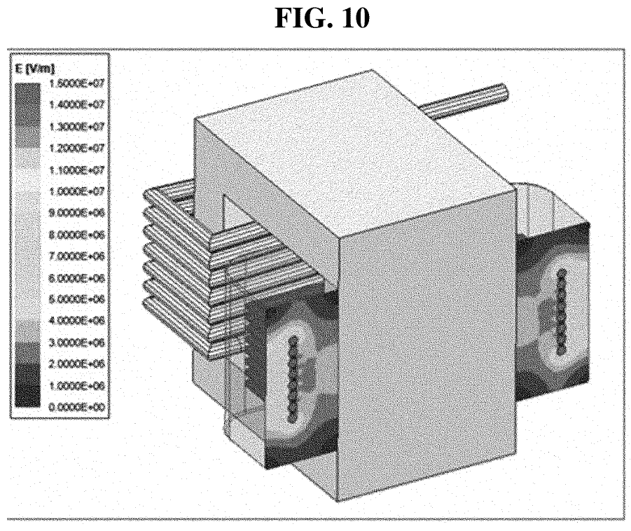

FIG. 8 is a graph showing an insulation analysis result of the insulation structure for the high frequency molded transformer according to the embodiment of the present inventive concept, FIG. 9 is a graph showing an insulation analysis result of the insulation structure for the high frequency molded transformer according to the embodiment of the present inventive concept, and FIG. 10 is a graph showing an internal insulation analysis result of the high voltage part of the insulation structure for the high frequency molded transformer according to the embodiment of the present inventive concept.

FIGS. 8 and 9 show the measurement results for the leaking electric field occurring on the outer surfaces of the epoxy mold 132 when an electric current is applied to the high voltage part winding 131, and FIG. 10 shows the measurement results for the electric field produced in the interior of the epoxy mold 132 when an electric current is applied to the high voltage part winding 131.

Referring to FIGS. 8 and 9, it is found that a low electric field is measured on the outside of the epoxy mold 132. That is, it is appreciated that the electric field leaking to the outside of the epoxy mold 132 rarely exists. As shown in FIG. 4, this means the conductive coating layer 140 is connected to the external ground G.

Referring to FIG. 10, it is found that a low electric field is measured on the inside of the epoxy mold 132. That is, it is appreciated that the electric field is kept to a given level inside the epoxy mold 132. As shown in FIG. 5, this means the conductive coating layer 140 is connected to the ferrite core 120.

Therefore, the insulation structure 100 according to the present inventive concept reduces the thickness of the epoxy mold 132, thereby improving the heat emission performance thereof, and it blocks the electric field leakage through the conductive coating layer 140, thereby making it possible to be designed freely, without considering the influence of the electric field on the outside of the epoxy mold 132. As a result, the insulation structure 100 according to the present inventive concept is easily applied to railway vehicles, eco-friendly energy systems, and high-voltage direct current (HVDC) systems.

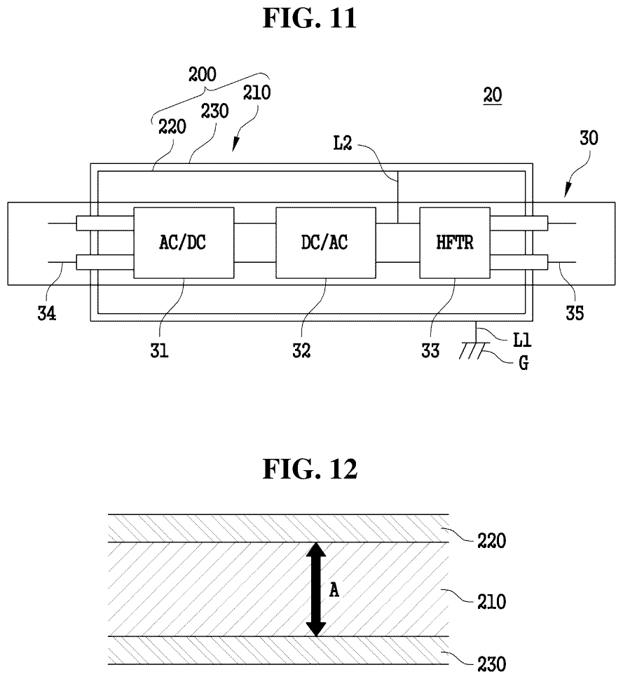

Now, an explanation of an insulation structure for a semiconductor transformer according to another embodiment of the present inventive concept will be given in detail with reference to the attached drawings. FIG. 11 is a schematic view showing an insulation structure for a semiconductor transformer according to another embodiment of the present inventive concept, and FIG. 12 is an enlarged sectional view showing an enclosure of the insulation structure for the semiconductor transformer according to the embodiment of the present inventive concept.

Referring to FIGS. 11 and 12, an insulation structure 200 for a semiconductor transformer according to another embodiment of the present inventive concept includes an enclosure 210, a first conductive coating layer 220, a second conductive coating layer 230, a first line L1, and a second line L2.

The insulation structure 200 for a semiconductor transformer 20 according to another embodiment of the present inventive concept is an insulation structure that is applied to a semiconductor transformer for a 23 kV medium voltage for railway vehicles. The insulation structure 200 makes use of epoxy having high insulation strength and conductive coating layers for blocking electric field leakage to thus prevent insulation breakdown from occurring due to high electric field on an air layer, while reducing an insulation distance between modules in the semiconductor transformer 20, so that the volume and weight of the semiconductor transformer 20 can decrease. In this case, the semiconductor transformer 20 includes an internal module 30.

The enclosure 210 is an enclosure for receiving the internal module 30 of the semiconductor transformer 20. In this case, the enclosure 210 is formed of an insulating body. For example, the enclosure 210 is formed of an epoxy mold. In this case, epoxy can resist a higher electric field than air, without any insulation breakdown. In this case, the enclosure 210 obtains the internal voltage of 70 kV produced from a system for a 23 kV medium voltage, thereby preventing the insulation breakdown occurring due to high electric field on the air layer. Therefore, the enclosure 210 more reduces an insulation distance than the case where insulation is made only using air.

In this case, a thickness of the enclosure 210 between the first conductive coating layer 220 and the second conductive coating layer 230 is determined to allow 70 kV insulation to be stably performed. Desirably, the thickness A of the enclosure 210 is greater than or equal to 10 T.

Even in the case where the enclosure 210 is made of epoxy, an electric field exists between the outer surfaces of the enclosure 210 and the components around the enclosure 210, so that insulation breakdown may occur on the air layer on the outside of the enclosure 210. According to the present inventive concept, the first conductive coating layer 220 and the second conductive coating layer 230 are formed on the inner surfaces and outer surfaces of the enclosure 210 to prevent the insulation breakdown from occurring due to the high electric field on the air layer.

The first conductive coating layer 220 is applied to the outer surfaces of the enclosure 210. That is, the first conductive coating layer 220 is applied to the entire outer surface of the enclosure 210. For example, the first conductive coating layer 220 is formed of a conductive paint.

The first line L1 connects the first conductive coating layer 220 and an enclosure ground G to each other. That is, the first conductive coating layer 220 is connected to the enclosure ground G through the first line L1.

In this case, the enclosure ground G transmits the electric field generated from the first conductive coating layer 220 to an earth ground and thus prevents the electric field leakage from occurring. That is, as the electric field is created only within the enclosure 210, the insulation breakdown does not occur in the air at the outside of the enclosure 210.

Like this, the insulation structure 200 according to another embodiment of the present inventive concept is configured to allow the first conductive coating layer 220 to be applied to the outer surfaces of the enclosure 210 and then connected to the ground, so that the electric field leakage is blocked to prevent the insulation breakdown from occurring on the outer surfaces of the enclosure 210.

The second conductive coating layer 230 is applied to the inner surfaces of the enclosure 210. That is, the second conductive coating layer 230 is applied to the entire inner surface of the enclosure 210. For example, the second conductive coating layer 230 is formed of a conductive paint.

The second line L2 connects the second conductive coating layer 230 and high voltage components of the internal module 30 to each other. That is, the second conductive coating layer 230 is connected to the high voltage components through the second line L2.

In this case, since a voltage difference between the components having high voltages inside the enclosure 210 and the second conductive coating layer 230 applied to the inner surfaces of the enclosure 210 is not big, no insulation breakdown occurs inside the enclosure 210.

Like this, the insulation structure 200 according to another embodiment of the present inventive concept is configured to allow the second conductive coating layer 230 to be applied to the inner surfaces of the enclosure 210 and then connected to the high voltage components of the internal module 30, so that as a voltage difference between the components inside the internal module 30 and the second conductive coating layer 230 of the enclosure 210 is not big, insulation breakdown inside the enclosure 210 is prevented from occurring.

The internal module 30 is an internal structure of the semiconductor transformer 20 that converts a distribution voltage of a 25 kV medium voltage level into 1 to 3 kV at which a commercial switching device is operable. The internal module 30 includes an AC/DC rectifier 31, a DC/AC inverter 32, a High Frequency Transformer (HFTR) 33, a high voltage terminal 34, and a low voltage terminal 35.

The AC/DC rectifier 31 is a multi-level AC/DC rectifier that performs series connection of distribution voltages of 22.9 or 23 kV medium voltage level. The AC/DC rectifier 31 converts alternating current power into direct current power.

The DC/AC inverter 32 converts the direct current power rectified through the AC/DC rectifier 31 into alternating current power.

The HFTR 33 is a high frequency transformer that converts a high voltage as an input voltage into a low voltage of 1 to 3 kV at which a commercial switching device is operable. The HFTR 33 minimizes parasitic capacitance and high frequency ringing.

The high voltage terminal 34 serves as an input part of the semiconductor transformer 20 and receives a voltage of 22.9 or 25 kV. In this case, the high voltage terminal 34 is exposed to the outside from the enclosure 210.

The low voltage terminal 35 serves as an output part of the semiconductor transformer 20 and transmits a voltage of 1 to 3 kV. In this case, the low voltage terminal 35 are exposed to the outside from the enclosure 210 in such a way as to face the high voltage terminal 34.

Like this, the insulation structure 200 according to another embodiment of the present inventive concept is configured to allow the conductive materials to be coated on the inner and outer surfaces of the enclosure 210 and then connected to the ground and the high voltage components of the internal module 30, so that as insulation distances among the components are reduced to minimize the volume and weight of the semiconductor transformer 20, there is no need to additionally ensure an insulation distance from another module, thereby being easy in achieving a stack structure, module integration, and packaging.

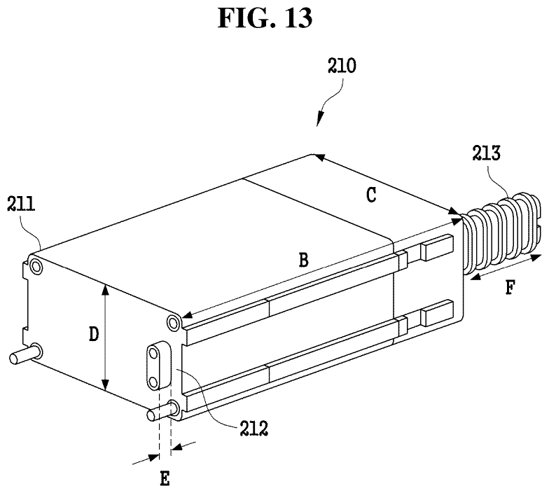

FIG. 13 is a perspective view showing the semiconductor transformer to which the insulation structure according to the embodiment of the present inventive concept is applied.

Referring to FIG. 13, the enclosure 210 includes a body 211, a first drawn part 212, and a second drawn part 213.

The body 211 receives the internal module 30. In this case, the body 211 has the shape of a rectangle. Desirably, the body 211 has a length B of 1000 to 1800 mm. Desirably, the body 211 has a width C of 250 to 400 mm. Desirably, the body 211 has a height D of 250 to 450 mm.

The first drawn part 212 protrudes outward from one side of the body 211. In this case, the first drawn part 212 is connected to a low voltage part of the internal module 30. That is, the low voltage terminal 35 as shown in FIG. 11 is located on the first drawn part 212. As shown in FIG. 13, the first drawn part 212 is located on the left side of the body 211.

The second drawn part 213 protrudes outward from the other side of the body 211. In this case, the second drawn part 213 is connected to a high voltage part of the internal module 30. That is, the high voltage terminal 34 as shown in FIG. 11 is located on the second drawn part 213. As shown in FIG. 13, the second drawn part 213 is located on the right side of the body 211.

In this case, the second drawn part 213 is longer than the first drawn part 212. For example, the length of the second drawn part 213 is seven times longer than that of the first drawn part 212. Desirably, a length E of the first drawn part 212 is between 15 and 30 mm, and a length F of the second drawn part 213 is 210 mm. As a result, the enclosure 210 achieves insulation of 70 kV.

Like this, the insulation structure 200 for the semiconductor transformer according to another embodiment of the present inventive concept is configured to allow the length of the second drawn part 213 and the length of the first drawn part 212 have a given relation to each other, thereby stably achieving the insulation characteristics required by a customer.

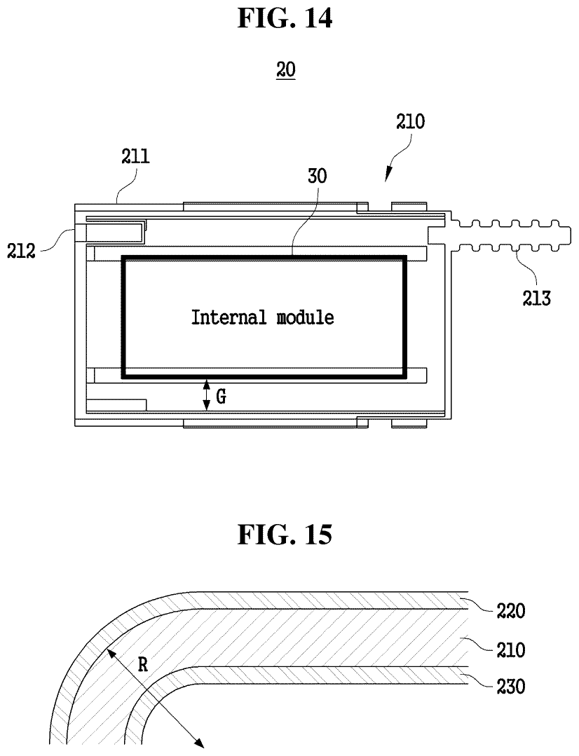

FIG. 14 is a sectional view showing the semiconductor transformer to which the insulation structure according to the embodiment of the present inventive concept is applied.

Referring to FIGS. 13 and 14, the internal module 30 is received inside the enclosure 210. In this case, the internal module 30 is spaced apart from the inner surfaces of the enclosure 210 by a given distance D, excepting the first drawn part 212. Desirably, the given distance D between the inner surfaces of the enclosure 210 and the internal module 30 is greater than or equal to 5 mm when the internal module 30 has a voltage of 1000 V.

Like this, the insulation structure 200 for the semiconductor transformer according to another embodiment of the present inventive concept is configured to allow the thickness A of the enclosure 210 and the distance between the inner surfaces of the enclosure and the internal module to have the given values, thereby stably achieving the insulation characteristics required by a customer.

FIG. 15 is an enlarged sectional view showing a corner of the enclosure of the insulation structure for the semiconductor transformer according to the embodiment of the present inventive concept.

Referring to FIG. 15, each corner of the enclosure 210 has a given curvature R. In this case, since the enclosure 210 has the shape of a rectangular parallelepiped, an electric field is collected on the respective corners. As a result, insulation breakdown may occur around the corners of the enclosure 210. To solve such a problem, each corner of the enclosure 210 has the given curvature R. Desirably, the corner curvature R of the enclosure 210 is greater than or equal to ½ of the thickness A of the enclosure 210. In this case, if the corner curvature R of the enclosure 210 is less than ½ of the thickness A of the enclosure 210, the electric field is collected on the respective corners, so that the insulation breakdown occurs around the corners of the enclosure 210.

Like this, the insulation structure 200 for the semiconductor transformer according to another embodiment of the present inventive concept is configured to allow the corner curvature R of the enclosure 210 to have a given relation with the thickness A of the enclosure 210, so that the electric field around the respective corners is distributed to prevent the insulation breakdown from occurring around the corners of the enclosure 210.

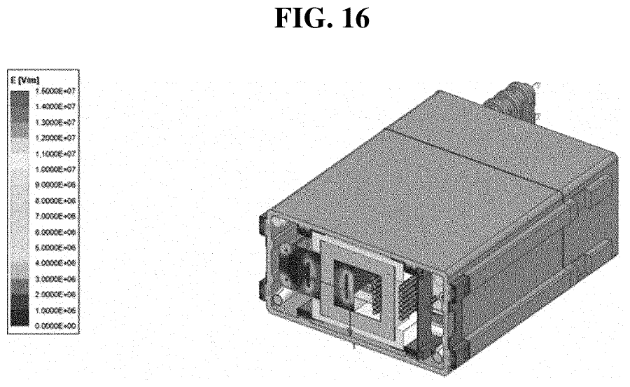

FIG. 16 is a sectional view showing insulation analysis on the enclosure of the insulation structure for the semiconductor transformer according to the embodiment of the present inventive concept.

Referring to FIG. 16, electric fields are measured inside and outside the semiconductor transformer and displayed on the sections of the respective components of the semiconductor transformer. In this case, the electric field becomes higher as colors are close to red, so that a possibility of insulation breakdown may increase. However, as shown in the section of the enclosure 210 of the semiconductor transformer according to the preset inventive concept, the electric field on the enclosure 210 is not high. Above all, the electric field on the internal module 30 of the enclosure 210 is not high. Therefore, no insulation breakdown occurs inside and outside the enclosure 210.

Therefore, it should be understood that the present inventive concept is not limited by the embodiments as will be discussed later and has all modifications in the technical spirit and scope of the present inventive concept. That is, the present inventive concept may be freely modified by those of ordinary skill in the art through addition, change, and deletion of the components thereof within the scope of the inventive concept limited by the claims appended hereto, and the modifications may be within the scope of the claims.

1. An insulation structure for a transformer, comprising a low voltage part winding, a ferrite core, and a high voltage part,
wherein the high voltage part comprises:
a high voltage part winding wound on one side of the ferrite core;
an epoxy mold located to surround the high voltage part winding;
a terminal protruding outward from one side of the epoxy mold; and
a shield located to surround the outer peripheral surface of the terminal, and
the epoxy mold has a conductive coating layer formed on the outer surfaces thereof in such a way as to be connected to ground or the ferrite core.

2. The insulation structure according to claim 1, wherein a distance between the conductive coating layer and the high voltage part winding is greater than or equal to a horizontal distance between the ferrite core and the high voltage part winding or a height distance between the high voltage part winding and the ferrite core.

3. The insulation structure according to claim 1, wherein the conductive coating layer is spaced apart from the ferrite core and connected to the ground through a connection line.

4. The insulation structure according to claim 1, wherein the conductive coating layer is applied to come into close contact with the ferrite core.

5. An insulation structure for a transformer equipped with an internal module, comprising:
an enclosure made of an insulating material;
a first conductive coating layer applied to the outer surfaces of the enclosure; and
a second conductive coating layer applied to the inner surfaces of the enclosure,
wherein the first conductive coating layer is connected to ground and the second conductive coating layer is connected to a high voltage side of the internal module.

6. The insulation structure according to claim 5, wherein the enclosure has a corner curvature (R) greater than or equal to ½ of a thickness (A) thereof.

7. The insulation structure according to claim 6, wherein the thickness (A) of the enclosure is greater than or equal to 10 T and a distance between the internal module and the inner surfaces of the enclosure is greater than or equal to 5 mm.

8. The insulation structure according to claim 5, wherein the enclosure comprises:
a body for receiving the internal module;
a first drawn part protruding outward from one side of the body in such a way as to be connected to a low voltage part of the internal module; and
a second drawn part protruding outward from the other side of the body in such a way as to be connected to a high voltage part of the internal module, the second drawn part being seven times longer than the first drawn part.
